(19) United States
(12) Patent Application Publication
(10) Pub. No.: US 2007/0020146 A1
(43) Pub. Date: Jan. 25, 2007

(54) Nanopore structure and method using an insulating substrate

(76) Inventors: James E. Young, La Honda, CA (US); Carol T. Schembri, San Mateo, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/171,091

(22) Filed: Jun. 29, 2005

(51) Int. Cl. G01N 27/00

(52) U.S. Cl. 422/82.01; 422/98

(57) ABSTRACT

A nanopore structure for conducting analysis on a molecule in solution. The nanopore structure includes an electrically insulating substrate and a membrane contacting the electrically insulating substrate. A nanopore is defined through the electrically insulating substrate and the membrane for conducting analysis on a molecule being positioned in the nanopore. Also disclosed are methods for making and using the nanopore structures.

### BACKGROUND

Various nanopore structures have been developed and designed for characterizing, sequencing and detecting small molecules. Some of the older designs include the use of stochastic sensing in ionic solutions to finger print or characterize molecules. However, these solution based nanostructures and systems lack a number of important characteristics that would make them feasible models for commercialization. Therefore, more recently, the field has evolved to more sophisticated and stable techniques that include the use of electronics, electrodes and semi-conductor materials for tunneling and resonance tunneling. These devices and techniques apply state of the art electrical and semiconductor technology to provide enhanced performance and analysis capabilities. To date, most of these technologies still require a solution that is typically split between one or more reservoirs. However, solutions based systems combined with nanopore structures made of semi-conductor materials have created a number of unexpected problems. The main undesirable property being that these materials cause capacitance problems. More specifically, the capacitance can cause the detection signals to have undesirably low amplitude effecting overall signal to noise ratios. This may provide inaccurate measurements, potential sequence misreading or loss of overall signal.

It, therefore, would be desirable to design a nanopore structure that provides for improved accuracy in measurements in solution, yet is capable of sequencing or characterizing a molecule without these limitations. These and other problems in the art have been obviated by the present invention.

### SUMMARY OF THE INVENTION

The invention provides a nanopore structure for conducting analysis on a molecule in solution. The nanopore structure comprises an electrically insulating substrate, and a membrane contacting the electrically insulating substrate wherein a nanopore is defined through the electrically insulating substrate and the membrane to define the nanopore structure.

The invention also provides a method for making nanopore structures. The method comprises forming an aperture through an electrically insulating substrate, filling the aperture in the electrically insulating substrate with a temporary support material, applying a membrane to the insulating substrate across the temporary support material, removing the temporary support material to expose the membrane and forming a nanopore through the membrane to define the nanopore structure.

### BRIEF DESCRIPTION OF THE DRAWINGS

FIG. 1 shows a diagrammatic representation of the nanopore structure of the present invention.

FIGS. 2A-2I show elevation views of the steps of one method in making the nanopore structure of the present invention.

FIGS. 3A-3F show elevation views of the steps in a second method for making a nanopore structure of the present invention.

FIGS. 4A-4I show elevation views of the steps in another method of making a nanopore structure.

FIGS. 5A-5G show elevation views of the steps in a method of making a nanopore structure with electrodes.

FIGS. 6A-6G show a plan view of the steps in the method shown in FIGS. 5A-5G.

FIG. 7 shows a graphical representation of the improvement in amplitude and noise level provided by an embodiment of the present invention as compared to a prior art device.

### DETAILED DESCRIPTION

Before describing the invention in detail, it must be noted that, as used in this specification and the appended claims, the singular forms “a,” “an,”and “the” include plural referents unless the context clearly dictates otherwise. Thus, for example, reference to “a nanostructure” includes more than one “nanostructure”. Reference to an “a nanopore” includes more than one “nanopore”. In describing and claiming the present invention, the following terminology will be used in accordance with the definitions set out below.

The term “adjacent” refers to something that is near, next to or adjoining. For instance, an electrode that is adjacent to a nanopore may be near the nanopore, may be next to the nanopore or may be adjoining the nanopore.

The term “rigid” refers to one or more non-conductive materials or compositions that are capable of being designed with one or more nanopores through them. In addition, they must be functionally capable of maintaining a sufficiently tensile state or structure when placed over a second nanopore. Various materials are known in the semiconductor and biological arts that are capable of exhibiting such functional properties. For instance, certain materials comprise, but are not limited to, silicon nitride, silicon dioxide, titanium dioxide etc.

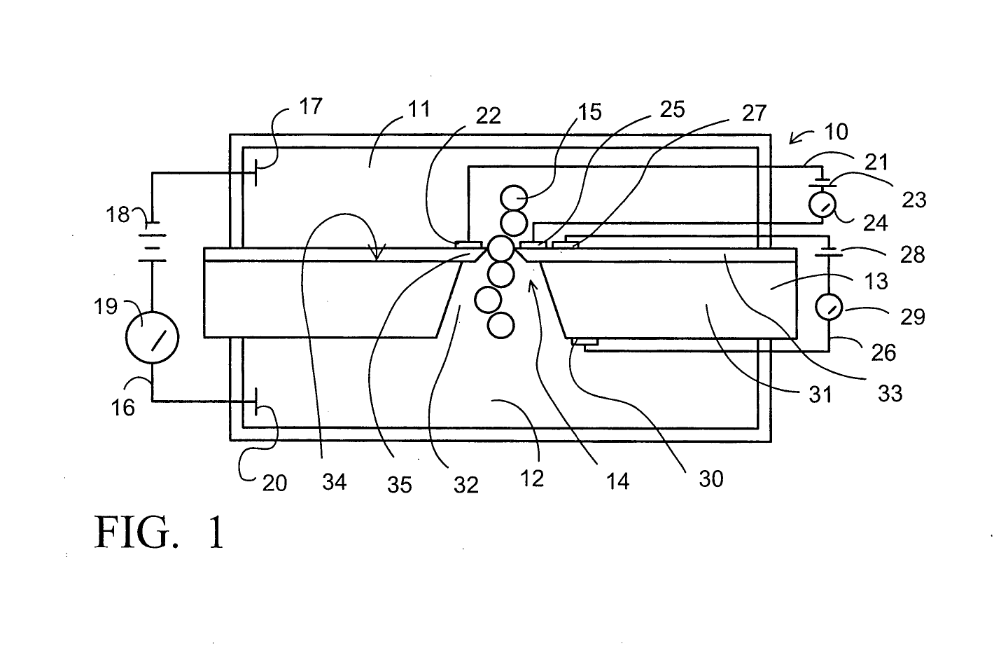

A nanopore system 10 of the present invention is shown in FIG. 1. The nanopore system 10 comprises a nanopore structure 13, a first reservoir 11 and a second reservoir 12.

Optionally, the nanopore system 10 may further comprise a first electrical system 16. The first electrical system 16 comprises a first voltage source 18, an ammeter 19, a first reservoir electrode 17 and a second reservoir electrode 20. The first electrical system 16 is design to aid in tranlocating a molecule 15 from the first reservoir 11 to the second reservoir 12, by way of a nanopore 14.

As discussed above, the first electrical system 16 may comprise the first voltage source 18, the ammeter 19, the first reservoir electrode 17 and the second reservoir electrode 20. The first voltage source 18 is electrically connected with one or more electrodes and typically can create an electrical potential between the first reservoir 11 and the second reservoir 12. The first voltage source 18 may also be electrically connected to the ammeter 19. The optional ammeter 19 monitors the flow of electricity through the nanopore 14. Because the flow of electricity through the nanopore 14 is affected by the positioning of the molecule 15 in the nanopore 14, detection or analysis of the molecule 15 is possible.

The nanopore structure 13 embodying the principles of the present invention is shown in FIG. 1. The nanopore structure 13 comprises an electrically insulating substrate 31, and a membrane 34 contacting the electrically insulating substrate 31 wherein the nanopore 14 is defined through the electrically insulating substrate 31 and the membrane 34. The nanopore structure 13 is designed for conducting analysis on the molecule 15 being translocated and positioned within the nanopore 14. The nanopore structure 13 may be immersed into solution to define the first-fluid-reservoir 11 and the second fluid reservoir 12. The first fluid reservoir 11 and the second fluid reservoir 12 are typically in fluid communication with each other.

The nanopore structure 13 may also optionally comprise a second electrical system 21 and a third electrical system 26. Each of these systems is optional. The present invention may be operated with one, both or neither of these systems. The second electrical system 21 further comprises a first electrode 22, a second voltage source 23, a second electrode 25 and a first signal monitor 24.

Referring now to the second electrical system 21 in FIG. 1, the second voltage source 23 may be in electrical connection with the first electrode 22 and the second electrode 25. The first electrode 22 and the second electrode 25 may be positioned on the membrane 34 adjacent to the nanopore 14. The first signal monitor 24 may also be employed and in electrical connection with the first electrode 22 and the second electrode 25. The first signal monitor 24 conducts a longitudinal conductance measurement on the nanopore 14. Because the geometry of the molecule 15 in the nanopore 14 affects the longitudinal conductance of the nanopore 14, analysis of the molecule may be possible.

Referring now to the third electrical system 26 in FIG. 1, the third voltage source 28 is in electrical connection with a third electrode 27 and a fourth electrode 30. The third electrode 27 may be positioned on the membrane 34 adjacent to the nanopore 14, while the fourth electrode 30 may be positioned on the electrically insulating substrate 31. The third voltage source 28 is also electrically connected to an optional third signal monitor 29. The optional third signal monitor 29 conducts a transverse conductance measurement across the nanopore 14. Because the geometry of the molecule 15 in the nanopore 14 affects the transverse conductance of the nanopore 14, analysis of the molecule may be possible.

Nanopores of the present invention may comprise various diameters. For instance, 1-1000 nanometer, 1-100 nm, or 1-20 nanometer. Other sizes known in the art may be employed with the present invention.

The membrane 34 may comprise a number of known materials in the art. It is important, however, that these materials maintain a rigid structure. The material may comprise glass, ceramic, plastic, or other nonconductive material. It is important to the invention that the membrane material maintain a certain amount of rigidity to support its own weight before and after a nanopore has been designed or sculpted in it.

Electrically insulating substrate 31 is important to the present invention. By employing an electrically insulating substrate 31, the capacitance problems in solution can be eliminated. Electrically insulating substrate 31 may comprise a number of materials known in the art. For instance, borosilicate glass or other non-conductive material may be employed. Other materials may comprise silicon nitride, silicon dioxide, titanium oxide, other oxides, plastics or any non-conducting material capable of being deposited in a thin layer and supporting its own weight when acting as a membrane over a second nanopore. Other materials may also be employed that are non-conductive, easy to sculpt and etch in and which allow for the application of one or more layers of membrane materials.

Having described the nanopore structure in detail, a description of the method of operating and making the device is now in order.

### Nanopore Structure Operation and Design

The operation of the present invention will now be described. The nanopore structure 10 may be employed without the above described electrodes. Various techniques are known in the art for using such nanopore structures. The embodiment(s) in which the optional electrodes are employed, will now be described in detail.

The nanopore structure 10 is designed with nanopore 14 for receiving a molecule 15. The molecule 15 may comprise any number of biological or non-biological materials that are capable of being detected or characterized. Ideally, nanopore 14 must be large enough for molecule 15 to move through it. This may be from the first reservoir 11 to the second reservoir 12 (or visa versa). Note that the drawing shows one configuration, but others are possible where the electrodes are in other arrangements, orientations or positions. The invention should not be interpreted to be limited to the portrayed embodiment(s). The method of the present invention comprises aligning the molecule in the nanopore structure 10 and detecting the molecule in the nanopore structure by applying an electrical conductance to at least one set of electrodes. The electrodes typically are positioned adjacent to the nanopore 14 of the nanopore structure 10.

The combination of the second voltage source 23 with the first electrode 22 and second electrode 25 provide a way for detecting the portion of molecule 15 positioned between the first electrode 22, the second electrode 25 and within the nanopore 14. The second voltage source 23 provides a voltage between the electrodes that is changed by the nature, chemistry and character of the portion of the molecule 15 that is positioned in the nanopore 14.

The combination of the third voltage source 28, the third electrode 27 and the fourth electrode 30 provide a way for detecting the portion of the molecule 15 positioned between the third electrode 27 and the fourth electrode 30. In particular, this pair of electrodes provides a way for determining the transverse positioning of a portion of the molecule 15 within the nanopore 14. The method described allows for ease in detecting and characterizing molecules.

Having described the method of using the invention, a description of the method of making the nanopore structure 13 and associated components is now in order.

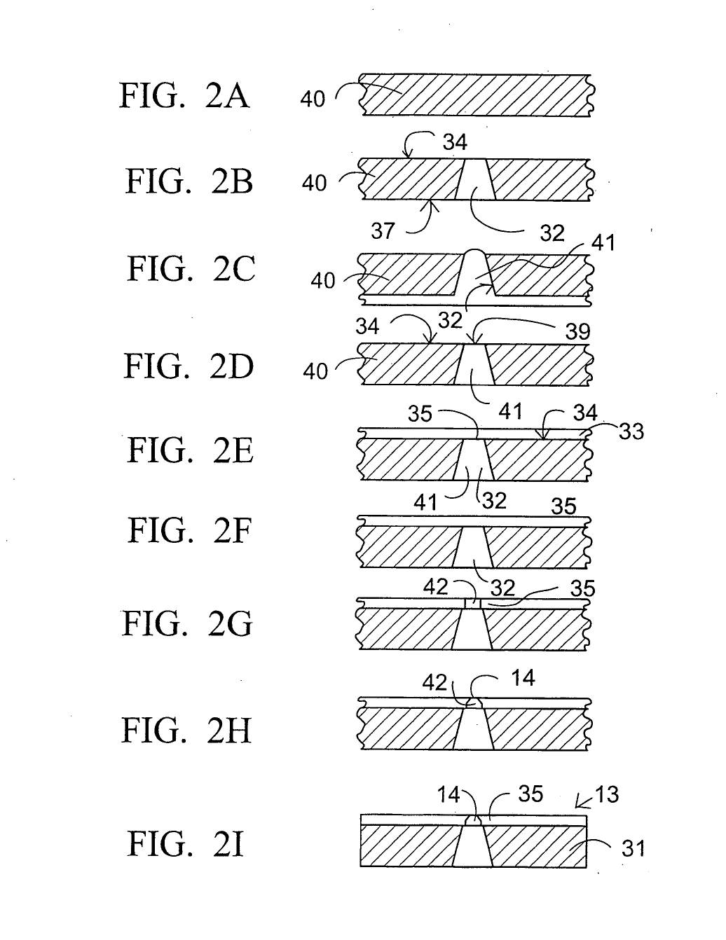

As shown in FIG. 2A, this first process begins with a non-conductive substrate 40. The non-conductive substrate may be glass, ceramic or plastic. The material thickness may be 0.1 mm to 5 mm, more conveniently 0.2 to 2 mm and most conveniently 0.5 mm thick. The length, width, diameter or shape of the material may be any that is convenient to handle during the manufacturing process. In this example, the selected substrate was a round solid glass non-conductive substrate 100 mm diameter and a thickness of 0.5 mm. FIG. 2 A represents a portion of the non-conductive substrate which will eventually become the electrically insulating substrate 31.

As shown in FIG. 2B, the second step is to drill the relatively large hole through the non-conductive substrate 40. Laser drilling may most conveniently form these holes. Alternatively, conventional drilling, e-beam lithography, EDM (electrical discharge machining) and the like may be employed to form the holes. Plastic substrates may be conveniently molded with the holes in place. In this specific example, these glass non-conductive substrates are processed by laser drilling to form a pattern of individual holes 32 separated by a distance of typically 10 mm. The substrate holes 32 are approximately 0.075 mm (75 micron) diameter on the second surface 37 of the substrate and approximately 0.050 mm (50 micron) diameter on the first surface 34 of the substrate and are drilled on grid spacing in the non-conductive substrate 40. The holes 32 may be any size from 1-1000 micron. They may be conical or straight. They are spaced on the non-conductive substrate in a convenient pattern for subsequent processing. The grid pattern may be any size.

As shown in FIG. 2C, the substrate holes 32 in the non-conductive substrate 40 (in this example, a 100 mm glass non-conductive substrate) are then plugged using any material that can withstand the subsequent application of the membrane layer and later be removed. Exemplary materials are spin-coating materials such as polyimide (e.g., Kapton ®), adhesives, spin-on glass and the like to form a plug 41 in each substrate hole 32. The plug is caused to flow into the holes during a spin process. This is a typical process used in non-conductive substrate coating where the coating material is spun on the non-conductive substrate in precursor form and then heated to cure it. Alternatively, the plug material is forced or pressed into each hole 32 and cured as necessary. The material may be cured by time, UV light exposure or heat as appropriate. In this example, the plug material was spin-on polyimide which was subsequently heat cured.

As shown in FIG. 2D, the non-conductive substrate may then be polished if necessary, removing any residual material on the surface and leaving the holes plugged with plugs 41 to form a flat surface 39 on the first surface 34 of the non-conductive substrate 40.

As shown in FIG. 2E, a layer 33 of the membrane material, is then deposited on this first surface 34 of the non-conductive substrate 40. The membrane thickness may generally be 1-1000 nm, more typically 50-500 nm and still more typically 200-500 nm. In this example, SiNx was selected as the membrane material and was deposited to a thickness of 200 nanometers.

As shown in FIG. 2F, the plugs 41 in the substrate holes 32 are then etched away leaving a thin membrane 35 across the opening of the substrate holes 32.

As shown in FIG. 2G, the center of the thin membrane 35 across each substrate hole is drilled using a FIB (focused ion beam) to produce a base membrane hole 42. If the final desired Nanopore diameter is larger than approximately 30 micron, the final hole is formed in the membrane layer by the focused ion beam process and the non-conductive substrate moves to the step shown in FIG. 21. If the final desired diameter is less than approximately 30 microns, then the focused ion beam process is employed to form a hole of approximately 70 nanometers and the process moves to the step shown in FIG. 2H. This hole 42 can range from 30 nm to 100 nm. Typically, one hole is placed in each membrane, however, a plurality of holes may be placed in each membrane if desired.

As shown in FIG. 2H, the substrate is then put in an ion sculpting system and bombarded with ions around each base membrane hole 42, causing a narrowing of the membrane hole to form a modified membrane hole or nanopore 14 having the desired final diameter. This process is regularly used to form nanopores of approximately 1-5 nanometers. (Reference: Li, Jiali et al., Ion Beam Sculpting on the Nanometre length scales Nature 412 166-169(12 Jul. 2001) As shown in FIG. 21, the non-conductive substrate 40 is then diced (cut, ground, or sawed) into numerous individual nanostructures 13, each having an electrically insulating substrate to 31, a thin membrane 35, and a nanopore 14 formed in the thin membrane 35. The step 21 can be placed anywhere in the process as is convenient for processing. The size of the final nanopore structure 13 can be any that is convenient for use. Each nanopore structure 13 may comprise one or more nanopores.

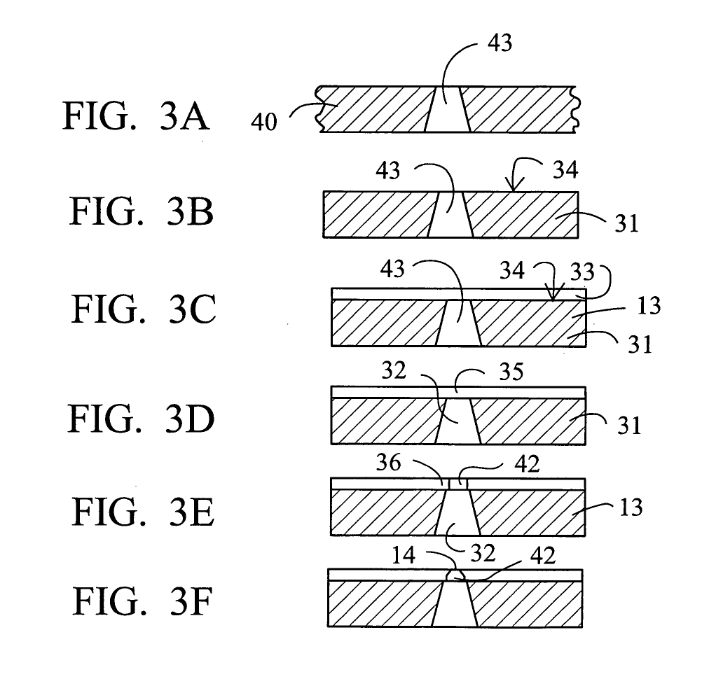

As shown in FIG. 3A, the second process begins with formation of non-conductive substrate 40 with rods 43 of etchable material such as etchable glass in the appropriate position and of the correct size, so that, when the rods are later etched out, the result is the formation of substrate holes 32 of essentially the same geometry as the substrate holes 32 formed in Process One outlined above. These non-conductive substrates may be any convenient size. Their thickness may be 0.1 mm to 5 mm, more conveniently 0.2 to 2 mm and most conveniently 0.5 mm thick. In this example, the non-conductive substrates were round and of 100 mm diameter and a thickness of 0.5 mm.

As shown in FIG. 3B, the non-conductive substrates are then cut or “diced” into individual nanostructures 13 and the first surface 34 of each nanostructure and the end of the rod 43 that shares that first side are polished to provide a required surface finish on the first surface 34 of the substrate and the rods. Alternatively, the entire non-conductive substrate is polished on the first surface 34 of the substrate and the dicing step is left to a later step in the process.

As shown in FIG. 3C, the electrically insulating substrate 31 of the nanopore structure 13 or the entire non-conductive substrate 40 then receives a deposited surface membrane layer 33. As noted above, this layer may be formed of any material capable of supporting its own weight when it is a membrane. In this example, a membrane of SiNₓ is deposited on the substrate's first surface 34 to a thickness of approximately 200 nanometers. This membrane covers the first surface end of the rod 43. The layer thickness may range from 1-1000 nanometers.

As shown in FIG. 3D, the rod 43 or “plug” is then etched away leaving a membrane 35 over the hole 32 in the electrically insulating substrate 31.

As shown in FIG. 3E, each nanopore structure 13 is then placed in a focused Ion beam path and a base hole 42 of approximately 70 nanometers diameter is bored through the SiNₓ membrane 36 at the center of the individual hole 32. As noted above, if the final desired hole is larger than approximately 30 micron, the final hole is formed in the membrane layer by the focused ion beam process. If the final desired diameter is less than approximately 30 microns, then the focused ion beam process is employed to form a hole of approximately 50-70 nm and the process continues to step 3F.

As shown in FIG. 3F, the 50-70 nanometer base membrane hole 42 is then narrowed to its final desired diameter 14 using an Ion sculpting system, that is, the hole is bombarded with ions causing a flow and deposits to narrow the diameter of the hole. If the nanopore will be used to test DNA, a final diameter of 1-5 nm is convenient.

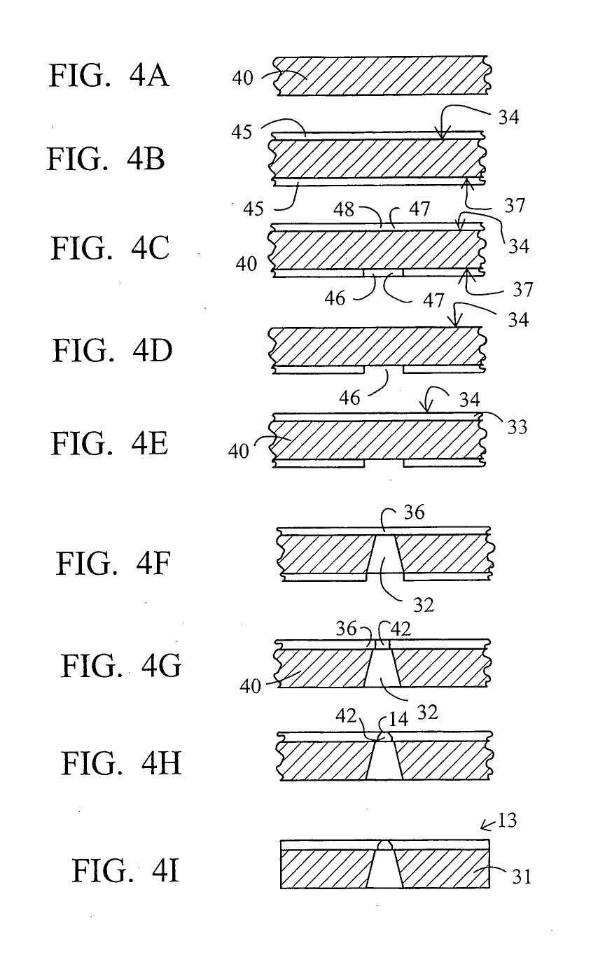

As shown in FIG. 4A, an etchable glass (e.g, FOTURAN ® brand photo-etchable glass) is used as a substrate. This insulating substrate may be of any convenient size. Its thickness may range from 0.1 mm to 5 mm, more conveniently 0.2 to 2 mm and most conveniently 0.5 mm thick. The shape and size may be any that is convenient. In this example, the standard non-conductive substrate of 400 mm diameter and 0.5 mm thickness was used.

As shown in FIG. 4B, the first surface 34 and the second surface 37 of the electrically insulating substrate 40 are covered with a spun-on layer of raw photoresist 45.

As shown in FIG. 4C, the raw photoresist 45 is exposed and processed through a mask of the desired substrate hole pattern, leaving dissolvable windows 46 of dissolvable photoresist 47 on the second surface 37 of the non-conductive substrate, where the holes in the glass are to be located, and a dissolvable layer 48 of dissolvable photoresist 47 on the first surface 34 of the non-conductive substrate 40.

As shown in FIG. 4D, the photo-etchable glass substrate is then exposed, that is, the dissolvable photoresist 47 is removed, leaving an exposed first surface 34 and exposed windows 46 where substrate holes 32 are desired.

As shown in FIG. 4E, a surface membrane layer 33 of material is deposited on the first surface 34 of the non conductive substrate 40. This membrane is any material that will support its own weight as noted in earlier examples. In this example, the membrane selected was silicon nitride, SiNx.

As shown in FIG. 4F, the exposed glass, located where the substrate holes 32 are desired, is then etched away down to the membrane 36 of Silicon Nitride, leaving the Silicon Nitride as a membrane 36 over the glass holes 32.

As shown in FIG. 4G, the non-conductive substrate 40 is then placed in a Focused Ion beam (FIB) path and a base membrane hole 42 of approximately 50 nanometers diameter is bored through the SiNx membrane 36 at the center of each substrate hole 32. More than one hole can be bored into the membrane of each substrate hole. As noted in earlier examples, the hole size may vary.

As shown in FIG. 4H, the base membrane hole 42 is then narrowed to a nanopore 14, if desired, using an Ion sculpting system, that is, the hole is bombarded with ions causing a flow and deposits to narrow the diameter of the hole.

As shown in FIG. 4I, the non-conductive substrate 40 is diced into individual nanostructures 13. As noted in earlier examples, this dicing step may occur anywhere in the process in which it is convenient. A final chip may comprise one or more nanopores.

### Electrode Process—Addition of Tunneling Electrodes to the Insulated Nanostructure

In one embodiment of this invention, electrodes, such as tunneling electrodes, are added to the nanostructure structure, to enhance the molecular analysis.

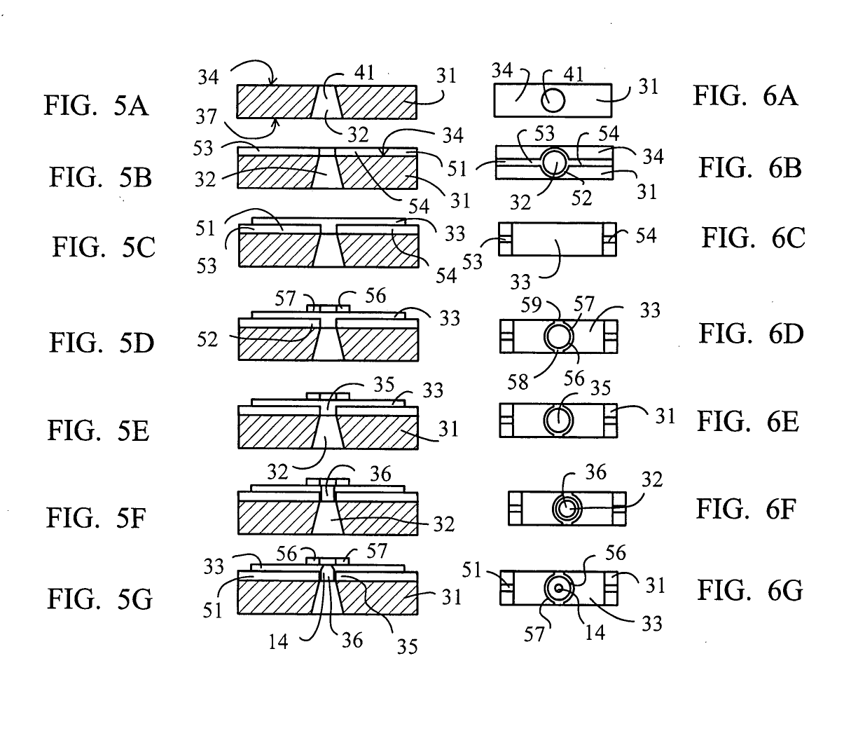

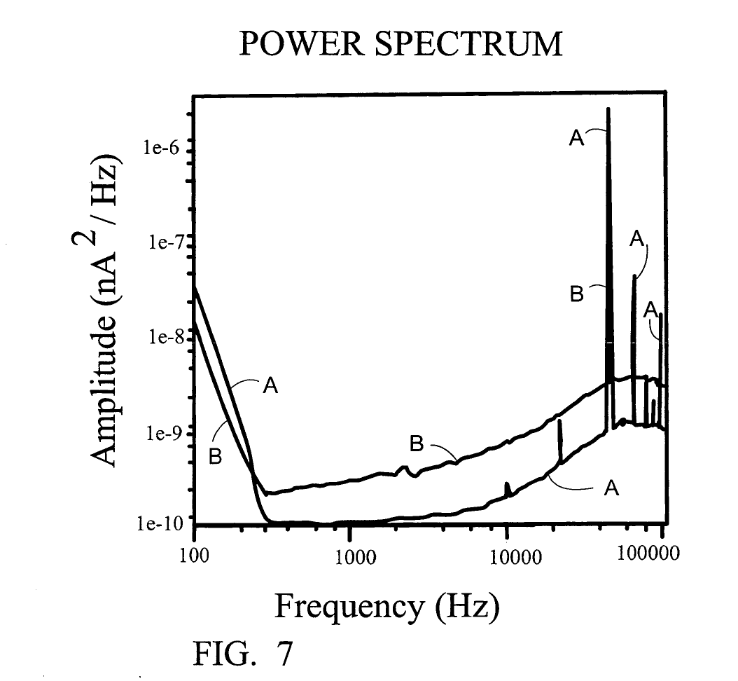

As shown in FIG. 5A and 6A, this process begins with a non-conductive substrate 40 or individual nanostructures 13 as described above, with a first surface 34 and a second surface 37. Removable plugs 41 are provided in the non-conductive substrate 40 at the locations that substrate holes 32 are desired, using one of the methods described above or otherwise. The plugs 41 are flush with the first surface 34. The first surface 34 is bare.

As shown in FIG. 5B and 6B, a first electrically conductive electrode 51 is deposited onto the first surface 34 of the electrically insulating substrate 31 in a pattern that forms an annulus 52 around each plugged potential substrate hole 32. The electrode also has two arms 53 and 54 on the first surface 34, the two arms 53 and 54 extending in opposite directions from the periphery of the annulus 52. This deposition may be any convenient thickness from 1-1000 nm and most conveniently would be approximately 10- 20 nanometers in thickness.

As shown in FIG. 5C and 6C, over base electrode 51 and surrounding glass substrate, a membrane layer 33 is deposited. The membrane layer may be any convenient material that is capable of supporting its own weight. In this example, SiNx was deposited. The thickness, as noted earlier, may range from 1-1000 nm. In this example, a layer thickness of 500 nm was deposited. The membrane layer 33 does not cover the outboard ends of the electrode arm 53 and 54 so that those ends are available for electrical connection to signal monitors.

As shown in FIG. 5D and 6D, on top of the outer surface of this membrane layer 33, top electrode 56 is deposited, in a pattern similar to the first electrode. The top electrode 56 forms an annulus 57 on the same vertical axis and in alignment with the annulus 52 of the base electrode 51 and plugged hole 32. The top electrode 56 also has two arms 58 and 59 on the outer surface of the membrane layer 33, both of the arms 58 and 59 of the top electrode 56 extending from the annulus 57 of the top electrode 56 at 90 degrees with respect to the arms 53 and 54 of the base electrode 51.

As shown in FIG. 5E and 6E, the plugs 41 are removed from the holes 32 in the substrate 31, leaving the membrane layer 33 and membrane 35 across each of the substrate holes 32.

As shown in FIG. 5F and 6F, the membrane 35 across the substrate hole 32 is drilled using a Focused Ion Beam (FIB) to produce a hole 36 of approximately 70 nanometers diameter. As noted earlier, this hole size can range from 30-1000 nanometers depending on the final desired size of the Nanopore. If the final size is greater than 30 nm, this stepforms the final pore. If the final size is less than 30 nm, the focused ion beam is used to drill a hole approximately 70 nm and then the process proceeds to the next step.

As shown in FIG. 5G and 6G, the substrate 31 is put in an ion sculpting system and the hole 36 in the membrane 35 is bombarded with ions around the 70 nanometer membrane hole 36, narrowing this hole 36 to the final desired size to form a nanopore 14. For DNA measurements, nanopores of 1-5 nm are convenient and are regularly formed.

As shown in FIG. 5G and 6G, the final configuration with the electrodes is as follows, top to bottom: The sizes given are exemplary only.

A top electrode 56 with a hole in the annulus 57 of the top electrode 56.

A membrane layer 33 with a 1-5 nanometer nanopore 14 in it.

A base electrode 51 with a hole in the annulus of the base electrode 51.

The glass substrate 31 with one or more holes 32, each with a 50-micron diameter opening at the first surface of the substrate and a 75-micron diameter opening at the second surface of the substrate.

It will be understood that the sequencing of the electrode layers and the membrane layers could be in several different orders that would be determined by the processing, geometry, and electrical needs of the finished part's desired characteristic.

It will also be understood that the order of the processing steps in all embodiments of this invention may vary with the requirements of the final product. For example, it may be necessary in the processing steps to dice (cut) the nanostructures from the non-conductive substrates as described in the steps above prior to the Ion Sculpting process due to the fragility of the membranes suspended across the openings of the substrate holes.

FIG. 6 shows a comparison between a conventional nanostructure and a nanostructure embodying the principles of the present invention. Line A represents the signal output of a conventional semi-conductor nanostructure. Line B represents the signal output of a nanostructure embodying the principles of the present invention, in an identical set-up. It is clear that Line B represents a higher amplitude signal than line A. Furthermore, it is clear than Line B has less noise (lower amplitude spikes) than Line A. It should be understood that the spikes of Line A are much greater in amplitude than the spikes of Line B. At the high frequency end, the Line A spikes overlay and extend beyond the line B spikes.

We claim:

1. A nanopore structure for conducting analysis on a molecule in solution, comprising:
a) an electrically insulating substrate, and
b) a membrane contacting the electrically insulating substrate wherein a nanopore is defined through the electrically insulating substrate and the membrane to define the nanopore structure.

2. A nanopore structure as recited in claim 1, wherein the insulating substrate comprises a material selected from the group consisting of silicon dioxide, glass, ceramic and plastic.

3. A nanopore structure as recited in claim 1, wherein the membrane comprises a material selected from the group consisting of silicon nitride, silicon dioxide, and titanium dioxide.

4. A nanostructure as recited in claim 1, wherein the membrane comprises a rigid material.

5. A nanostructure as recited in claim 1, wherein the membrane comprises a partially rigid material.

6. A nanostructure as recited in claim 1, further comprising a first electrode adjacent to the nanopore.

7. A nanostructure as recited in claim 6, further comprising a second electrode adjacent to the nanopore.

8. A nanostructure as recited in claim 7, further comprising a voltage source in electrical connection with the first electrode and the second electrode.

9. A nanostructure as recited in claim 1, further comprising a third electrode contacting the membrane.

10. A nanostructure as recited in claim 9, further comprising a fourth electrode contacting the electrically insulating substrate.

11. A nanostructure as recited in claim 10, further comprising a voltage source in electrical connection between the third electrode and the fourth electrode.

12. A nanostructure as recited in claim 1, wherein the membrane comprises a thickness of from 1 to 1000 nanometers.

13. A nanostructure as recited in claim 1, wherein the membrane comprises a thickness of from 50 to 500 nanometers

14. A method of making a nanostructure, comprising:
a) forming an aperture through an electrically insulating substrate;
b) filling the aperture in the electrically insulating substrate with a temporary support material;
c) applying a membrane to the insulating substrate across the temporary support material;
d) removing the temporary support material to expose the membrane; and
e) forming a nanopore through the membrane to define the nanostructure.

15. A method as recited in claim 14, wherein the electrically insulating substrate comprises a material selected from the group consisting of silicon dioxide, silicon nitride and titanium.

16. A method as recited in claim 14, wherein the temporary support material is selected from the group consisting of polyimide, etchable glass, spin on glass and adhesives.

17. A method of detecting a molecule in a nanopore structure comprising a membrane, a non-conductive substrate and a set of electrodes, comprising:
(a) aligning the molecule in the nanopore structure; and
(b) detecting the molecule in the nanopore structure by applying an electrical conductance to the set of electrodes.
